(19) United States
(12) Patent Application Publication
(10) Pub. No.: US 2006/0074597 A1
(43) Pub. Date: Apr. 6, 2006

(54) Intelligent knowledge base for an alarm troubleshooting system

(75) Inventors: Adonny Raphael, Holmdel, NJ (US); Jeeva Srinivasan, Jackson, NJ (US)

Correspondence Address: COHEN, PONTANI, LIEBERMAN & PAVANE, 551 FIFTH AVENUE, SUITE 1210, NEW YORK, NY, 10176, US

(73) Assignee: Avaya Technology Corp.

(21) Appl. No.: 10/952,596

(22) Filed: Sep. 29, 2004

(51) Int. Cl. G06F 11/30

(52) U.S. Cl. 702/183

(57) ABSTRACT

A method and apparatus for troubleshooting information system use a graphical user interface (GUI) to a knowledge base of troubleshooting procedures for presenting the procedures in a graphical form, including a flow chart form and a decision tree form. In one embodiment, the troubleshooting procedures are further prioritized in an order of probability of solving a problem in a controlled system and retrieved in the prioritized order.

### BACKGROUND OF THE INVENTION

1. Field of the Invention

The present invention generally relates to a field of operating and maintaining complex systems and apparatuses. More specifically, embodiments of the present invention relate to a method and apparatus for computerized troubleshooting information systems.

2. Description of the Related Art

Troubleshooting of large computerized systems is time consuming process that, in many instances, is performed by expert service personnel. To preserve the knowledge acquired while correcting operational problems in such systems, definitions of the problems and successful troubleshooting procedures should be recorded for future use and/or training purposes.

When there is a problem, a device being under control generates an alarm that is forwarded to a computerized troubleshooting system including a knowledge base of troubleshooting instructions. Once the troubleshooting system receives the alarm, it retrieves the applicable rules or strategies from its knowledge base for this alarm based on the characteristics of the device (product type, firmware/software version, type of network in which it resides, and the like). Such procedures may further be executed either automatically or under supervision of the service personnel.

Conventionally, the content of troubleshooting procedures is interpreted by a programmer, coded, and stored in an information database in a form that requires, from a user of the database, knowledge of a specific command-oriented language to access a specific procedure. However, such a method of accumulating and presenting troubleshooting knowledge is also time consuming. Additionally, this method does not allow the users of the troubleshooting system (e.g., service engineers or technicians) to visualize a troubleshooting procedure or perform an automated search and prioritization of the procedures that are relevant to a particular problem or a class of problems.

Therefore, there is a need in the art in an improved method and apparatus for a troubleshooting information system.

### SUMMARY OF THE INVENTION

The present invention is generally directed to a method and apparatus for troubleshooting information system that uses a graphical user interface (GUI) and facilitates presentation of troubleshooting procedures in a graphical form.

In a first aspect of the invention, there is provided a troubleshooting information apparatus. In one embodiment, the apparatus comprises a GUI, a knowledge base (i.e., information database, electronic library or look-up table, and the like) of troubleshooting procedures, and a data controller. The data controller is coupled to the GUI and the knowledge base and converts the troubleshooting procedures in a file format that is compatible with the GUI that presents the procedures in a graphical form of a flow chart, a decision tree, and the like.

In a second aspect of the invention, there is provided a method for troubleshooting a controlled system using the inventive apparatus. In one embodiment, the method comprises steps of retrieving from the knowledge base and presenting troubleshooting procedures in a graphical form and troubleshooting the system using these procedures in a prioritized order.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

The teachings of the present invention will become apparent by considering the following detailed description in conjunction with the accompanying drawings, in which:

FIG. 1 depicts a block diagram of a troubleshooting information apparatus in accordance with one embodiment of the present invention; and

FIG. 2 depicts a flow diagram illustrating a method of troubleshooting a controlled system using the apparatus of FIG. 1 in accordance with one embodiment of the present invention.

Herein, identical reference numerals are used, where possible, to designate identical elements that are common to the figures.

The appended drawings illustrate exemplary embodiments of the invention and, as such, should not be considered limiting the scope of the invention that may admit to other equally effective embodiments.

### DETAILED DESCRIPTION OF THE PRESENTLY PREFERRED EMBODIMENTS

The present invention generally relates to a method and apparatus for an information troubleshooting system having a graphical user interface. Embodiments of the invention advantageously facilitate presentation of troubleshooting procedures in a graphical form.

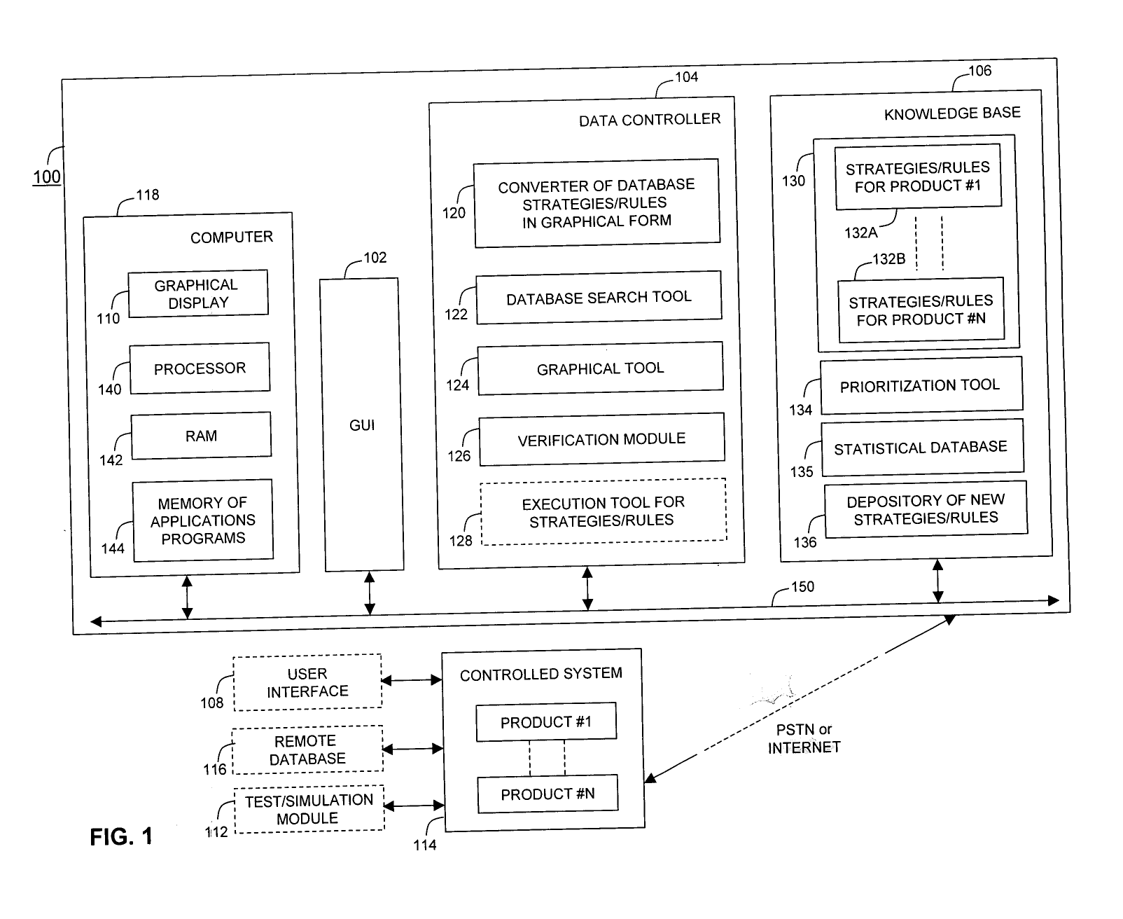

FIG. 1 depicts a block diagram of a troubleshooting information apparatus 100 in accordance with one embodiment of the present invention. The apparatus 100 generally comprises a computer 118, a graphical user interface (GUI) 102, a knowledge base 106 of troubleshooting procedures, and a data controller 104 that are coupled to a common bus 150. In one exemplary embodiment, a controlled system 114, an optional test/simulation module 112, an optional remote database 116, and an optional user interface 108 are also coupled to the bus 150 (not shown).

In a further embodiment (shown in FIG. 1), the test/simulation module 112, the remote database 116, and the optional user interface 108 may be a portion of the controlled system 114. The controlled system 114, as well as the remote database 116 and/or the test/simulation module 112, may be accessible by the apparatus 100 either directly (via, for example, wired connection to he bus 150, or via a modem connection accessing a public switched telephone network (PSTN) or an Internet connection such as HTTP, VPN or the like, as illustratively shown in FIG. 1.

The computer 118 conventionally comprises a CPU 140, a random access memory (RAM) 142, an applications memory 144 (e.g., hard drive memory), and a graphical display 110. In the depicted embodiment, the GUI 102, knowledge base 106, and data controller 104 are each reduced to practice in a form of computer programs (i.e., software) that are accessible by the computer system 118 and stored in a server computer (not shown). In an alternate embodiment (not shown), at least one of the GUI 102, knowledge base 106, and data controller 104 may be stored in the memory 144.

The GUI 102 is a program that facilitates user's graphical access to resources of the apparatus 100 and, in particular, to the knowledge base 106. Elements of the GUI 102 include a mouse and a plurality of widgets, such as icons, pull-down menus, scroll bars, selection boxes, and the like. Libraries of widgets may be found in application development languages, such as, e.g., Java, Tool Command Language®, and ActiveX Control®. In operation, the GUI 102 facilitates presentation of the content of the knowledge base 106 on the display 110 in a graphical form, as well as adding and/or modifying, in such a form, new data in the knowledge base 106. In one exemplary embodiment, GUI 102 supports graphical forms that include at least one of a flow chart form and a decision tree form.

In one embodiment, the knowledge base 106 includes an information unit 130 comprising at least one data bank 132 of troubleshooting procedures (two data banks 132A and 132B are shown), a prioritization tool 134, a statistical database 135, and a depository 136.

Each data bank of the information unit 130 contains a set of verified case-based troubleshooting procedures for a corresponding product (illustratively, Product #1 and Product #N are shown) of a controlled system 114. Examples of the controlled systems include wired and wireless communication networks, various control, command, and processing systems, and the like. A troubleshooting procedure typically addresses an operational problem of a specific product and includes a strategy (set of rules) for troubleshooting the alarm or at least one rule directed to better understanding a cause of the problem. Examples of the problems may include warning signals, failures and abnormal operational conditions, out-of-specification performance, and the like. Herein, such events in the controlled system 114 are collectively referred to as alarms. In a further embodiment, the troubleshooting procedures also include diagnostic routines.

The prioritization tool 134 is a computer program that analyses case-based strategies and rules stored in the information unit 130 and prioritizes them based on probability of success in resolving the alarm. Generally, prioritization criteria are set up using accumulated statistical data for resolving particular alarms or, in some cases, an assessment of an expert troubleshooter.

The statistical database 135 contains a historical log of the alarms data (alarm type, product type, troubleshooting success rate, date and time of the alarm, and the like). Such statistical data may be used by the prioritization tool 134 to establish prioritization rules.

The depository 136 is a portion of memory allocated for storing the strategies and rules that have not been verified and/or authorized for use in the controlled system 114. After positive verification (or authorization), such a strategy or rule is transferred to a respective data bank of the information unit 130. Accordingly, negative results of the verification procedure (or denial of authorization) may result in removal of the affected strategy or rule from the knowledge base 106.

In one embodiment, the data controller 104 comprises a data converter 120 and at least one of a knowledge base search tool 122, a graphical tool 124, a verification module 126, and an optional execution tool 128.

Generally, the troubleshooting procedures are stored in the information unit 130 in a non-graphical format. The data converter 120 converts the strategies and rules retrieved to solve the alarm in a file format compatible with the GUI 102. In a further embodiment, upon verification of validity of the conversion, the retrieved strategy and rules may be stored back in the knowledge base 106 in the file format compatible with the GUI 102 to be readily available for reviewing in the graphical form (e.g., flow chart, decision tree, and the like). In one embodiment, the troubleshooting procedures may be retried from and re-stored in the knowledge base 106 using the GUI 102.

The search tool 122 is used for retrieving for the knowledge base 106 the strategies and rules relating to specific problems and products. Generally, the search tool 122 uses identifiers, such as key words, and the like, as search criteria. In one embodiment, the identifiers are introduced using icons, symbols, selection boxes, or other means of the GUI 102.

The graphical tool 124 is used to add, in a graphical form, a new strategy and/or rule to the depository 136, as well as modify an existing troubleshooting procedure. The graphical tool 124 allows a user of the apparatus 100 to directly add and/or modify troubleshooting procedures, thus providing a means for updating the knowledge base 106 on an ongoing basis without programmer involvement. In an alternate embodiment, the graphical tool 124 may comprise a portion of the GUI 102. In a further embodiment, the new strategy and/or rule may be also transferred to the depository 136 from the remote knowledge base 116.

The verification module 126 validates the new strategy or rule against a pre-determined set of conditions and requirements, which typically include testing compatibility with product specifications, existing troubleshooting procedures, and the like. In a further embodiment, a validation process may include using, in an alarm simulation mode, the test/simulation module 112 or, on a limited scale, the controlled system 114.

The execution tool 128 may be used, in conjunction with the GUI 102, to perform the retrieved strategy or rule using the test/simulation module 112. The strategy or rule may be executed using GUI 102 and the computer 118 either in the alarm simulation mode as a training exercise or, in real time, upon the corresponding product of the controlled system 114.

The user interface 108 allows the end user (e.g., owner of the controlled system 114) access to resources of the apparatus 100. Selectively, access privileges may include full access, monitoring rights, knowledge base review rights, and the like. In the depicted embodiment, the controlled system 114 is also illustratively coupled to the apparatus 100 to facilitate automatic registration of the alarms and reporting on status of ongoing troubleshooting activities.

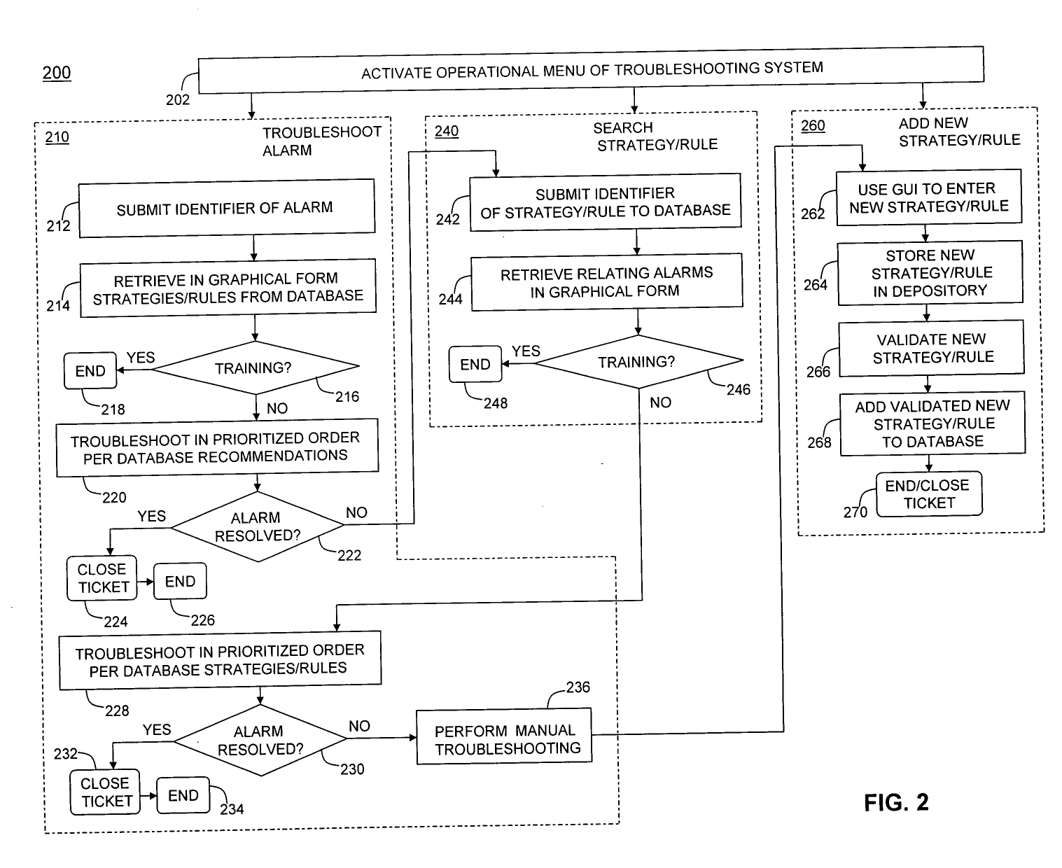

FIG. 2 depicts a flow diagram illustrating a method 200 for troubleshooting a controlled system using the troubleshooting information apparatus 100 of FIG. 1 in accordance with one embodiment of the present invention. To best understand the invention, the reader should simultaneously refer to FIGS. 1 and 2.

The method 200 starts at step 202 where GUI 102 is initiated to display an operational menu of the apparatus 100. In one exemplary embodiment, the menu includes sub-menus (or icons) of a “Troubleshoot Alarm” procedure 210, a “Search Strategy/Rule” procedure 240, and “Add New Strategy/Rule” procedure 260, among other choices (not shown).

The “Troubleshoot Alarm” procedure 210 starts at step 212 where an identifier of the alarm (e.g., an alpha-numeric identifier) is submitted, via the GUI 102, to the computer 118. At step 214, using the GUI 102, strategies and rules related to the alarm are retrieved from the corresponding data bank (e.g., data bank 132A) of the information unit 130 and, in a graphical form (e.g., flow chart and/or decision tree), are presented for review on the display 110. The strategies and rules presently stored in the knowledge base 106 in non-graphical formats are converted, using the data converter 120, in the graphical format compatible with the GUI 102, as discussed above in reference to FIG. 1.

At step 216, the procedure 210 queries if the retrieved strategies and rules are requested for training purposes. In one embodiment, the troubleshooting procedures are retrieved in a prioritized order or assigned the priority, as discussed in reference to FIG. 1 above. The training purposes generally include reviewing of the troubleshooting procedures by service personal or a user of the controlled system 114, training classes, and similar activities. If the query of step 216 is affirmatively answered, the procedure 210 proceeds to step 218, where the procedure ends. If the query of step 216 is negatively answered, the procedure 210 proceeds to step 220.

At step 220, the service personnel (or, in some cases, the user of the controlled system 114) troubleshoots the alarm using, in the prioritized order, the strategies and rules retrieved, at step 214 above, from the knowledge base 106. The graphical form of presenting the troubleshooting recommendations and instructions may significantly increase efficiency of understanding and executing the troubleshooting instructions.

At step 222, the procedure 210 queries if the alarm has been resolved. If the query of step 222 is affirmatively answered, the procedure 210 proceeds to step 224 where an alarm case, or ticket, is reported closed and then, at step 226, the procedure 210 ends. If the query of step 222 is negatively answered (i.e., none of the retrieved strategies or rules have solved the problem), the procedure 210 proceeds to step 242 of the “Search Strategy/Rule” procedure 240 to search the knowledge base 106 for additional troubleshooting recommendations (operation of the procedure 240 is discussed below).

At step 228, the service personnel troubleshoots the alarm using the additional troubleshooting recommendations that may be available in the knowledge base 106 (e.g., strategies and rules related to problems that are similar to the alarm being resolved) and discovered using the procedure 240. Such additional strategies and rules are also presented on the display 110 in the graphical form, as discussed above in reference to step 214.

At step 230, similar to step 222, the procedure 210 queries if the alarm has been resolved. If the query of step 230 is affirmatively answered, the procedure 210 proceeds to step 232 where the case ticket is reported closed and then, at step 234, the procedure 210 ends. If the query of step 230 is negatively answered (i.e. none of the additional strategies and rules solved the problem), the procedure 210 proceeds to step 236 of manual troubleshooting. Step 236 is typically performed by expert service personnel. In the depicted embodiment, upon resolving the alarm, the expert personnel adds, using the graphical tool 124, the successful troubleshooting procedure (i.e., new strategies and/or rules) to the knowledge base 106 using the “Add New Strategy/Rule” procedure 260. In this case, the procedures 210 and 260 (operation of the procedure 260 is discussed below) end together, at step 270.

The “Search Strategy/Rule” procedure 240 starts at step 242 where an identifier of a strategy or a rule (e.g., expression characterizing a specific troubleshooting routine or operational conditions in the controlled system, key word, and the like) is submitted to the computer 118. Such an identifier may be submitted using the GUI 102. At step 244, strategies and rules related to the identifier are retrieved, using the GUI 102, from the knowledge base 106 and, in a graphical form (e.g., flow chart and/or decision tree), are presented for review on the display 110. Similar to step 214 of the procedure 210, strategies and rules presently stored in the knowledge base 106 in non-graphical formats are converted, using the data converter 120, in the graphical format compatible with the GUI 102.

At step 246, the procedure 240 queries if the retrieved strategies and rules were requested for the training/information purposes. If the query of step 246 is affirmatively answered, the procedure 240 proceeds to step 248, where the procedure ends. If the query of step 246 is negatively answered, the procedure 240 proceeds to step 228, thus providing the service personnel with additional information for resolving the alarm, as discussed above in reference to the procedure 210.

The “Add New Strategy/Rule” procedure 260 starts at step 262 where, using the graphical tool 124 and GUI 102, a new strategy or a new rule (including modified existing troubleshooting instructions) is entered in the computer 118 in a form of a flow chart and/or a decision tree. At step 264, the new strategy or the new rule is stored in the depository 136. The step 266, using the validation module 126, the new strategy or the new rule undergo validation tests, as discussed above in reference to FIG. 1.

At step 268, the new strategy or the new rule that has passed the tests is removed from the depository 136 and re-stored in a respective data bank of the information unit 130. The failed troubleshooting instructions are, generally, discarded. Upon completion of step 268, at step 270, the procedure 260 ends. When adding the new strategy or the new rule to the knowledge base 106 is a portion of the procedure 210, at step 270, the procedure 210 ends too. In this case, since the new troubleshooting instructions have been positively tested at step 236, steps 264 and 268 are optional.

Thus, while there have been shown and described and pointed out fundamental novel features of the present invention as applied to preferred embodiments thereof, it will be understood that various omissions and substitutions and changes in the form and details of the devices described and illustrated, and in their operation, and of the methods described may be made by those skilled in the art without departing from the spirit of the present invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is the intention, therefore, to be limited only as indicated by the scope of the claims appended hereto.

1. A method of troubleshooting a controlled system, comprising:
(a) providing a knowledge base of troubleshooting procedures, the knowledge base accessible using a computer having a graphical user interface;
(b1) storing the troubleshooting procedures in the knowledge base in a non-graphical file format;
(b2) converting the troubleshooting procedures from the non-graphical file format into a file format compatible with the graphical user interface;
(b3) verifying validity of the file format conversion performed at step (b2);
(b4) storing in the knowledge base the troubleshooting procedures converted at step (b2);
(b5) prioritizing the troubleshooting procedures associated with an operational problem in the controlled system in an order of probability to solve the problem; and
(c) presenting the troubleshooting procedures to a user in a graphical form using at least one step of a group of steps consisting of (i) presenting the procedures in an order of priority determined at step (b5), (ii) presenting the procedures containing an identifier of the operational problem, and (iii) presenting the procedures in an order defined by the user so that the user can use the troubleshooting procedures presented in the graphical form to troubleshoot the controlled system.

2. (canceled)

3. The method of claim 1 wherein the step (b4) further comprises:
modifying and restoring in the knowledge base the troubleshooting procedures upon acquisition of new troubleshooting data.

4. The method of claim 1 wherein the step (c) further comprises:
presenting the troubleshooting procedures in a graphical form selected from a group consisting of a flow chart and a decision tree.

5. The method of claim 1 wherein the identifier is at least one of a key word and an alarm symbol associated with the operational problem.

6. The method of claim 1 wherein the step (b5) further comprises:
maintaining a historical log of the operational problems in the controlled system.

7. The method of claim 1 wherein the step (b4) further comprises:
adding new troubleshooting procedures into the knowledge base using the graphical user interface.

8. The method of claim 7 further comprising:
storing the new troubleshooting procedures using the file format compatible with the graphical user interface.

9. (canceled)

10. (canceled)

11. The method of claim 1 wherein the computer is further coupled to at least one of a user interface of the controlled system or a remote knowledge base of troubleshooting procedures.

12. A troubleshooting information system, comprising:
a computer having a graphical user interface;
a knowledge base of troubleshooting procedures accessible using the computers the knowledge base including:
an information unit comprising at least one data bank of the troubleshooting procedures for at least one controlled system;
a prioritization tool for prioritizing the troubleshooting procedures;
a database of historical operational problems;
a depository of proposed troubleshooting procedures; and
a controller coupled to the computer and the knowledge base, the controller including
a converter for converting the troubleshooting procedures into a file format compatible with the graphical user interface;
a search tool for retrieving the troubleshooting procedures from the knowledge base;
a verification tool for verifying the troubleshooting procedures against pre-determined conditions and requirements; and
a graphical tool for adding the troubleshooting procedures in a graphical form to the knowledge base.

13. The system of claim 12 wherein the controller is a portion of the graphical user interface.

14. The system of claim 12 wherein the graphical user interface presents the troubleshooting procedures to a user in a graphical form selected from a group consisting of a flow chart and a decision tree.

15. (canceled)

16. The system of claim 12 wherein the controller further comprises a troubleshooting procedure execution tool.

17. The system of claim 12 wherein the controller is further coupled to a test/simulation module of the at least one controlled system.

18. (canceled)

19. The system of claim 12 wherein the at least one data bank comprises troubleshooting procedures suitable for troubleshooting the at least one controlled system.

20. The system of claim 12 further coupled to at least one of a user interface of the at least one controlled system or a remote knowledge base of troubleshooting procedures.
